(19) United States
(12) Patent Application Publication
(10) Pub. No.: US 2023/0148115 A1
(43) Pub. Date: May 11, 2023

(54) DYNAMICALLY RECONFIGURABLE BATTERY MANAGEMENT ARCHITECTURE

(71) Applicant: GM GLOBAL TECHNOLOGY OPERATIONS LLC, Detroit, MI (US)

(72) Inventors: Steven E. MULDOON, Royal Oak, MI (US); Yue-Yun Wang, Troy, MI (US); Bin Li, Troy, MI (US); Lei Hao, Troy, MI (US)

(21) Appl. No.: 17/519,735

(22) Filed: Nov. 5, 2021

(51) Int. Cl. H01M 10/42; G07C 5/08; B60L 58/18; B60L 3/00; H01M 10/48

(52) U.S. Cl. CPC H01M 10/425; G07C 5/0808; B60L 58/18; B60L 3/0046; B60L 3/0092; H01M 10/486; B60L 2240/545; B60L 2240/547; B60L 2240/549; B60L 2260/00; H01M 2220/20; H01M 2010/4271

(57) ABSTRACT

A battery system for a vehicle includes a plurality of battery modules, each of the plurality of battery modules including a respective management module, and a master management module configured to communicate with the management modules and with a battery control module. Each of the management modules includes a communication interface configured to transmit data to the master management module and receive data from the master management module and a diagnostic module configured to monitor operating parameters of a respective one of the plurality of battery modules, detect a fault associated with the respective one of the plurality of battery modules based on the operating parameters, and selectively output a signal indicative of the detected fault.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles and more particularly to battery systems of vehicles.

Some types of vehicles include only an internal combustion engine that generates propulsion torque. Pure electric vehicles include a battery system and an electric motor. Hybrid vehicles include both an internal combustion engine and one or more electric motors and may include a battery system. The battery system includes one or more batteries or battery modules. Each battery module includes one or more battery cells.

### SUMMARY

A battery system for a vehicle includes a plurality of battery modules, each of the plurality of battery modules including a respective management module, and a master management module configured to communicate with the management modules and with a battery control module. Each of the management modules includes a communication interface configured to transmit data to the master management module and receive data from the master management module and a diagnostic module configured to monitor operating parameters of a respective one of the plurality of battery modules, detect a fault associated with the respective one of the plurality of battery modules based on the operating parameters, and selectively output a signal indicative of the detected fault.

In other features, the fault is thermal runaway of a temperature of the respective one of the plurality of battery modules.

In other features, the diagnostic module is an application specific integrated circuit.

In other features, the operating parameters include at least one of a voltage, temperature, impedance, pressure, and current of the respective one of the plurality of battery modules.

In other features, at least one of the management modules is configured to selectively operate as a backup master management module.

In other features, the at least one of the management modules is configured to operate as the backup master management module in response to a determination that at least one of a fault is detected in one of the plurality of battery modules, a fault is detected in the master management module, and a fault is detected in a communication network used by the master management module.

In other features, the diagnostic module is configured to monitor the operating parameters of the respective one of the plurality of battery modules in a sleep mode.

In other features, in the sleep mode, at least one of the vehicle and the battery control module is powered off.

In other features, the diagnostic module is configured to wake up the battery control module in response to detecting a fault in the respective one of the plurality of battery modules.

In other features, to wake up the battery control module, the diagnostic module is configured to wake up the master management module.

In other features, each of the management modules is configured to selectively transition the communication interface to a broadcast beacon mode.

In other features, each of the management modules is configured to selectively transition the communication interface to the broadcast beacon mode in response to a determination that a fault is detected in the respective one of the plurality of battery modules and a fault is detected in a wireless communication network.

In other features, a method operates a battery system that includes a master management module and a plurality of battery modules each comprising a respective management module. The method includes, using a respective communication interface of each of the management modules, transmitting data to the master management module and receiving data from the master management module and, using a respective diagnostic module of each of the management modules, monitoring operating parameters of a respective one of the plurality of battery modules, detecting a fault associated with the respective one of the plurality of battery modules based on the operating parameters, and selectively outputting a signal indicative of the detected fault.

In other features, the fault is thermal runaway of a temperature of the respective one of the plurality of battery modules.

In other features, the operating parameters include at least one of a voltage, temperature, impedance, pressure, and current of the respective one of the plurality of battery modules.

In other features, the method further includes configuring at least one of the management modules to operate as a backup master management module in response to a determination that at least one of a fault is detected in one of the plurality of battery modules, a fault is detected in the master management module, and a fault is detected in a communication network used by the master management module.

In other features, the method further includes, using the diagnostic module, monitoring the operating parameters of the respective one of the plurality of battery modules in a sleep mode, wherein, in the sleep mode, at least one of the vehicle and a battery control module is powered off.

In other features, the method further includes waking up the battery control module in response to detecting a fault in the respective one of the plurality of battery modules while in the sleep mode.

In other features, the method further includes selectively transitioning one of the management modules to a broadcast beacon mode.

In other features, the method further includes selectively transitioning the communication interface of the one of the management modules to the broadcast beacon mode in response to a determination that a fault is detected in the respective one of the plurality of battery modules and a fault is detected in a wireless communication network.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIGS. 2A and 2B are a functional block diagram of an example battery system of a vehicle;

FIG. 3 illustrates steps of an example method for selecting a backup master management module according to the present disclosure;

FIG. 4 illustrates steps of an example method for operating a battery system in a sleep mode according to the present disclosure; and

FIG. 5 illustrates steps of an example method for operating a management module of a battery system in a radio beacon mode according to the present disclosure.

In the drawings, reference numbers may be reused to identify similar and/or identical elements.

### DETAILED DESCRIPTION

Electric or hybrid electric vehicles typically include one or more rechargeable batteries or battery modules each including a plurality of battery cells. In some examples, each battery module has an associated management module comprising a wireless device configured to communicate information about the battery module. (e.g., a measured voltage of the battery module). A battery system may include a plurality of the management modules and a master management module. The management modules communicate the information about the respective battery modules to the master management module, which in turn communicates the information to a higher abstraction battery control module or management system (which may be implemented using a vehicle management system).

Battery management systems and methods according to the present disclosure implement management modules configured to monitor, detect, and process faults (e.g., thermal runaway, or TRA) associated with respective battery modules. In other words, each individual management module is configured to perform measurements, diagnostics (including fault prediction), and processing associated with a respective battery module. In some examples, one or more of the management modules may be configured to selectively operate as a master management module (e.g., as a backup master management module in the event of a systemic failure affecting the originally-designated master management module).

Thermal runaway may refer to a condition where heat generated by a battery or battery module exceeds an amount of heat that is dissipated to the environment. When this occurs, the temperature of one battery may cause other batteries in the battery system to also be heated at a rate that exceeds heat dissipation.

Although described herein with respect to vehicle batteries (e.g., rechargeable batteries for electric or hybrid vehicles), the principles of the present disclosure may be applied to batteries used in non-vehicle applications.

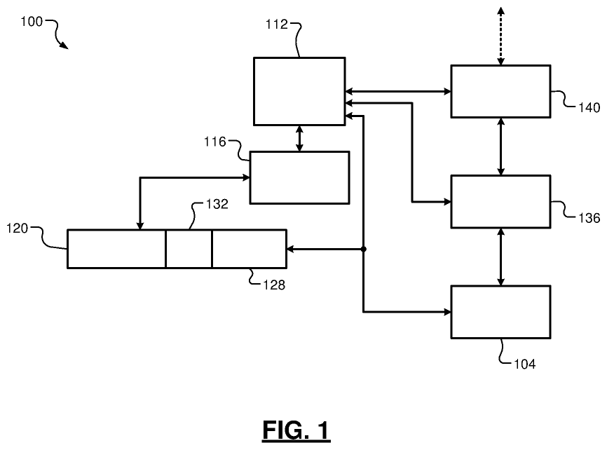

Referring now to FIG. 1, a functional block diagram of an example vehicle system 100 including a battery system 104 according to the present disclosure is shown. The vehicle system 100 may correspond to an autonomous or non-autonomous vehicle. The vehicle may be an electric vehicle (as shown). In other examples, the principles of the present disclosure may be implemented in a hybrid electric vehicle or a non-vehicle application.

A vehicle control module 112 controls various operations of the vehicle system 100 and the engine 108 (e.g., acceleration, braking, etc.). The vehicle control module 112 may communicate with a transmission control module 116, for example, to coordinate gear shifts in a transmission 120. The vehicle control module 112 may communicate with the battery system 104, for example, to coordinate operation of an electric motor 128. While the example of one electric motor is provided, multiple electric motors may be implemented. The electric motor 128 may be a permanent magnet electric motor or another suitable type of electric motor that outputs voltage based on back electromagnetic force (EMF) when free spinning, such as a direct current (DC) electric motor or a synchronous electric motor. In various implementations, various functions of the vehicle control module 112 and the transmission control module 116 may be integrated into one or more modules.

Electrical power is applied from the battery system 104 to the electric motor 128 to cause the electric motor 128 to output positive torque. For example, the vehicle control module 112 may include an inverter or inverter module (not shown) to apply the electrical power from the battery system 104 to the electric motor 128. The electric motor 128 may output torque, for example, to an input shaft of the transmission 120, to an output shaft of the transmission 120, or to another component. A clutch 132 may be implemented to couple the electric motor 128 to the transmission 120 and to decouple the electric motor 128 from the transmission 120. One or more gearing devices may be implemented between an output of the electric motor 128 and an input of the transmission 120 to provide one or more predetermined gear ratios between rotation of the electric motor 128 and rotation of the input of the transmission 120.

A battery control module (comprising, for example, a vehicle management system) 136 is configured to control functions of the battery system 104 including, but not limited to, controlling switching of individual battery modules or cells of the battery system 104, monitoring operating parameters, diagnosing faults, etc. The battery control module 136 may be further configured to communicate with a telematics module 140. The battery system 104 according to the principles of the present disclosure includes a plurality of management modules configured to monitor, detect, and process faults associated with respective battery modules of the battery system 104 as described below in more detail.

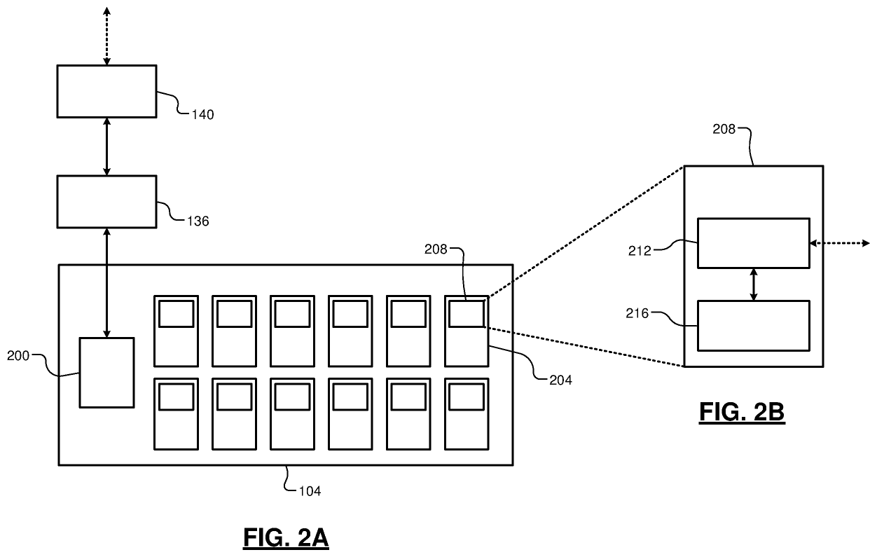

FIGS. 2A and 2B show an example of the battery system 104 according to the present disclosure in more detail. The battery system 104 includes a master management module (MM) 200 and a plurality of battery modules 204 each including a respective management module (MM) 208. In some examples, each of the battery modules 204 may be comprised of a plurality of individual battery cells. Each of the management modules 208 is configured to monitor, detect, and process faults (e.g., thermal runaway) associated with a respective one of the battery modules 204. In other words, each individual management module 208 is configured to perform measurements, diagnostics (including fault prediction), and processing associated with a respective battery module 204.

As shown in FIG. 2B, each of the management modules 208 includes a communication interface (e.g., a wireless and/or wired communication interface) 212 configured to communicate data bi-directionally with the master management module 200, which in turn is configured to communicate (e.g., transmit and received data wirelessly and/or via a vehicle bus) with the battery control module 136. The management module 208 further includes a diagnostic module 216, which may be implemented as a processor configured to executed one or more algorithms stored in memory, and, application specific integrated circuit (ASIC), etc.

The diagnostic module 216 is configured to monitor (e.g., directly measure or sense) and/or estimate or calculate operating parameters (i.e., local measurements) of the battery module 204 including, but not limited to, voltage, current, temperature, pressure, and impedance. The diagnostic module 216 is further configured to execute one or more algorithms to diagnose and/or predict faults of the battery module 204 such as thermal runaway based on the operating parameters. Results of the algorithms (e.g., diagnostic results) can be communicated to the master management module 200 or, in some examples, directly to the battery control module 136.

Accordingly, each diagnostic module 216 is configured to obtain local measurements corresponding to a respective one of the battery modules 204, execute one or diagnostic algorithms to detect or predict faults using the local measurements, and transmit the local measurements and/or the diagnostic results (e.g., to the battery control module 136, directly and/or indirectly via the master management module 200). In some examples, the diagnostic module 216 may be configured to detect conditions of wireless network quality (e.g., quality of service parameters, such as signal strength). In some examples, the diagnostic module 216 receives additional information from others of the management modules 208, the master management module 200, and/or the battery control module 136. For example, the diagnostic module 216 may be configured to receive an overall current draw of the battery system 104 (as calculated by the master management module 200 or the battery control module 136), faults detected by others of the management modules 208, a wireless network signal strength (e.g., as diagnosed by the battery control module 136), etc.

Conversely, the battery control module 136 receives the local measurements for each of the battery modules 204, diagnostic results (e.g., detected faults) from respective ones of the management modules 208, etc. The battery control module 136 is configured to selectively perform one or more fault mitigation steps based on the diagnostic results. For example, in the event that a fault such as thermal runaway is detected, the battery control module 136 may deactivate the corresponding one of the battery modules 204.

One or more of the management modules 208 may be configured to selectively operate as a backup master management module instead of the master management module 200 in the event of a detected failure of the master management module 208 and/or another fault that may interfere with the operation of the master management module 208. For example, the battery control module 136, the master management module 200, and/or any one of the management modules 208 may detect various conditions requiring transfer of functionality of the master management module 200 to one of the management modules 208.

Conditions that may trigger reassignment of functions of the master management module 200 to one of the management modules 208 include, but are not limited to, quality of service of communication to or from the master management module 200 decreasing below a threshold, thermal runaway being detected in a battery module 204 (e.g., adjacent to) the master management module 200, and/or loss of communication with the master management module 200. In some examples, only one of the management modules 208 may be configured to be reassigned as the backup master management module. In other examples, The backup master management module may be dynamically assigned (e.g., to one of the management modules 208 furthest from the master management module 200, to one of the management modules 208 having a highest quality of service, etc.). In some examples, a predetermined number or percentage of the management modules 208 may be required to determine that the master management module should be reassigned, and/or select the backup master management module (e.g., using a voting algorithm).

The diagnostic module 216 may be configured to operate as described above when the vehicle (and, therefore, the battery control module 136) is powered off. In an example, each of the management modules 208 may operate in a reduced power or sleep mode when the vehicle is off. For example, when the vehicle is off, the management module 208 is powered by the battery module 204 and the diagnostic module 216 continues to obtain local measurements and perform diagnostics to detect or predict faults such as thermal runaway. In some examples, the diagnostic module 216 may configured to perform only a subset of monitoring functions during the sleep mode (e.g., measurements required to detect thermal runaway). In one example, if the diagnostic module 216 detects thermal runaway, the management module 208 transmits a “wake up” or other alert to battery control module 136 (which may activate and disconnect the corresponding battery module 204), to the master management module 200, to a user (e.g., via an app or other device), etc.

In some examples, each of the management modules 208 may be configured to selectively operate in accordance with a different communication protocol or radio mode in response to one or more detected faults or failures. For example, some events (e.g., collisions, thermal runaway, etc.) may cause a loss of wireless network communication (e.g., a Wi-Fi connection) between two or more of the management modules 208, the master management module 200, the battery control module 136, etc. If the diagnostic module 216 detects loss of wireless network communication and thermal runaway, the diagnostic module 216 may cause the management module 208 to reboot and reconfigure itself to transmit a warning beacon.

For example, the communication interface 212 may be configured to primarily communicate in a wireless network in a first bandwidth in a first radio mode. A second radio mode (e.g., broadcast radio beacon mode, such as a Bluetooth mode) may us a same or different frequency within the first bandwidth. Accordingly, the management module 208 may selectively reboot with the communication interface 212 in a Bluetooth mode and transmit a pulse or beacon at a Bluetooth frequency (e.g., 2.4 GHz). The beacon may indicate that the corresponding battery module 208 is still active (i.e., still connected despite the vehicle being powered off subsequent to a collision or other failure event).

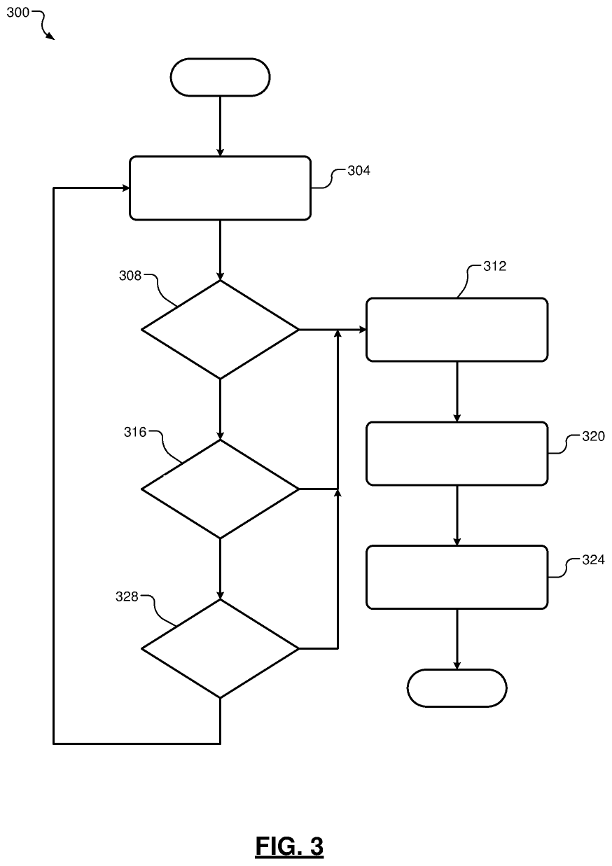

FIG. 3 is an example method 300 for reassigning/selecting a backup master management module according to the present disclosure. At 304, the method 300 (e.g., each of the management modules 208) monitors network conditions and conditions of respective battery modules 204. At 308, the method 300 (e.g., the management modules 208) determine whether a fault (e.g., thermal runaway) is detected for one of a selected group of the battery modules 204 (e.g., battery modules 204 within a predetermined distance of the master management module 200). If true, the method 300 continues to 312. If false, the method 300 continues to 316.

At 312, the method 300 reassigns one of the management modules 208 as a backup master management module. For example, one or more of the management modules 208 may be pre-assigned as the backup master management module, the method 300 may execute a voting or other selection algorithm to select the backup master management module, a management module 208 furthest away from the detected thermal runaway may be selected as the backup master management module, a management module 208 having the strongest network signal strength may be selected as the backup master management module, etc.

At 320, the method 300 (e.g., the battery control module 136, the master management module 200 the selected backup master management module, etc.) instructs remaining management modules 208 (i.e., management modules 208 not selected as the backup master management module) to reboot. For example, the management modules 208 reboot in a configuration that recognizes the selected management module 208 as the backup master management module. At 324, the entire wireless network may be rebooted to configure the selected management module 208 as the backup master management module.

At 316, the method 300 (e.g., the management modules 208, the battery control module 136, etc.) determines whether a fault or failure is detected in the master management module 200. For example, the master management module 200 may self-diagnose and indicate a fault or failure, any of the management modules 208 or the battery control module 136 may detect a failure of the master management module 200, etc. If true, the method 300 continues to 312 to select a backup master management module as described above. If false, the method 300 continues to 328.

At 328, the method 300 (e.g., the management modules 208, the battery control module 136, etc.) determines whether a fault or failure is detected in the wireless communication network. For example, any of the management modules 208 or the battery control module 136 may detect a loss of signal strength or other interruption in wireless communication from the master management module 200. If true, the method 300 continues to 312 to select a backup master management module as described above. If false, the method 300 continues to 304.

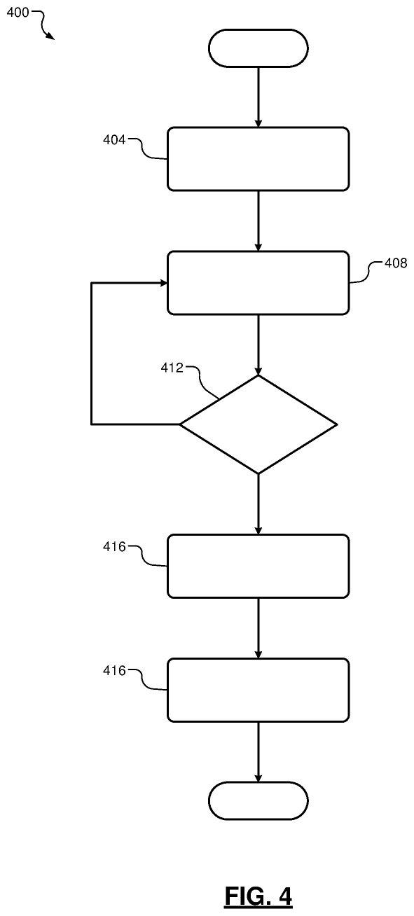

FIG. 4 is an example method 400 for operating the management modules 208 in a sleep mode according to the present disclosure. At 404, the method 400 enters the sleep mode. For example, the vehicle (and, accordingly, the battery control module 136) is powered off and the management modules 208 begin operating in the sleep mode. At 408, the method 400 (e.g., the management modules 208) operates in the sleep mode. In the sleep mode, the management modules 208 may operate at reduced power and/or functionality but continue to draw power from the battery modules 204. The reduced functionality may include monitoring battery conditions and parameters indicative of thermal runaway.

At 412, the method 400 (e.g., respective ones of the management modules 208) determines whether thermal runaway is detected. For example, each of the management modules 208 continues, during the sleep mode, to monitor and receive local measurements from the battery modules 204 and determines whether the local measurements are indicative or predictive of thermal runaway. If true, the method 400 continues to 416. If false, the method 400 continues to 408.

At 416, the method 400 (e.g., the management module 208 that detected thermal runaway) transmits a wakeup signal to the master management module 200. At 420, the master management module 200 transmits a wakeup signal to the battery control module 136. At 424, the battery control module 136 selectively performs one or more mitigation actions. For example, the battery control module 136 disconnects/deactivates one or more of the battery modules 204, transmits a warning message to a user, etc. In some examples, the management module 208 may transmit the wakeup signal directly to the battery control module 136, transmit a warning message to a user, etc.

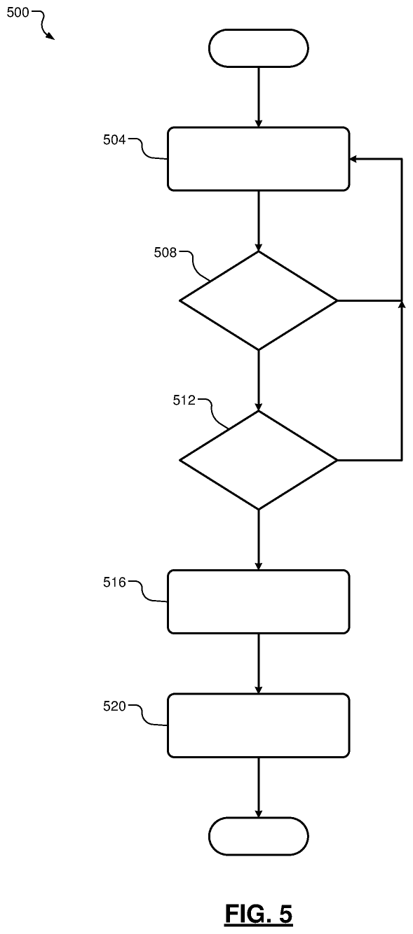

FIG. 5 is an example method 500 for operating in an alert broadcast mode according to the present disclosure. At 504, the method 500 (e.g., respective ones of the management modules 208) collects data, such as local measurements, indicative of operating parameters of the battery modules 204. For example, the management modules 208 monitor and receive local measurements from the battery modules 204. At 508, the method 500 (e.g., respective ones of the management modules 208) determines whether thermal runaway is detected. For example, each of the management modules 208 determines whether the local measurements are indicative or predictive of thermal runaway as described above in other embodiments. If true, the method 500 continues to 512. If false, the method 500 continues to 504.

At 512, the method 500 (e.g., respective ones of the management modules 208) determines whether the wireless communication network has failed. For example, the method 500 may determine whether (e.g., due to a collision or other event) the master management module 200, battery control module 136, etc. have stopped communicating on the network. If true, the method 500 continues to 516. If false, the method 500 continues to 508. In other words, in steps 508 and 512, the method 500 determines whether both thermal runaway and network communication failure have both occurred.

At 516, the method 500 (e.g., one or more of the management modules 208) switches to a radio beacon mode. For example, one or more of the management modules 208 that has detected both thermal runaway and network communication failure reboots in a Bluetooth configuration. At 520, the method 500 (e.g., the management module 208 configured in the radio beacon mode) transmits a beacon in accordance with the radio beacon mode. For example, the method 500 transmits a period beacon on a Bluetooth frequency that is detectable by another component of the vehicle, nearby vehicles or users, etc. The presence of the beacon may indicate that one or more of the battery modules 204 is experiencing thermal runaway and therefore is still drawing and/or providing power.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery system for a vehicle, the battery system comprising:
a plurality of battery modules, each of the plurality of battery modules including a respective management module; and
a master management module configured to communicate with the management modules and with a battery control module,
wherein each of the management modules includes
a communication interface configured to transmit data to the master management module and receive data from the master management module, and
a diagnostic module configured to monitor operating parameters of a respective one of the plurality of battery modules, detect a fault associated with the respective one of the plurality of battery modules based on the operating parameters, and selectively output a signal indicative of the detected fault.

2. The battery system of claim 1, wherein the fault is thermal runaway of a temperature of the respective one of the plurality of battery modules.

3. The battery system of claim 1, wherein the diagnostic module is an application specific integrated circuit.

4. The battery system of claim 1, wherein the operating parameters include at least one of a voltage, temperature, impedance, pressure, and current of the respective one of the plurality of battery modules.

5. The battery system of claim 1, wherein at least one of the management modules is configured to selectively operate as a backup master management module.

6. The battery system of claim 5, wherein the at least one of the management modules is configured to operate as the backup master management module in response to a determination that at least one of (i) a fault is detected in one of the plurality of battery modules, (ii) a fault is detected in the master management module, and (iii) a fault is detected in a communication network used by the master management module.

7. The battery system of claim 1, wherein the diagnostic module is configured to monitor the operating parameters of the respective one of the plurality of battery modules in a sleep mode.

8. The battery system of claim 7 wherein, in the sleep mode, at least one of the vehicle and the battery control module is powered off.

9. The battery system of claim 8, wherein the diagnostic module is configured to wake up the battery control module in response to detecting a fault in the respective one of the plurality of battery modules.

10. The battery system of claim 9 wherein, to wake up the battery control module, the diagnostic module is configured to wake up the master management module.

11. The battery system of claim 1, wherein each of the management modules is configured to selectively transition the communication interface to a broadcast beacon mode.

12. The battery system of claim 11, wherein each of the management modules is configured to selectively transition the communication interface to the broadcast beacon mode in response to a determination that (i) a fault is detected in the respective one of the plurality of battery modules and (ii) a fault is detected in a wireless communication network.

13. A method of operating a battery system for a vehicle, the battery system including a master management module and a plurality of battery modules each comprising a respective management module, the method comprising:
using a respective communication interface of each of the management modules, transmitting data to the master management module and receiving data from the master management module,
using a respective diagnostic module of each of the management modules,
monitoring operating parameters of a respective one of the plurality of battery modules,
detecting a fault associated with the respective one of the plurality of battery modules based on the operating parameters, and
selectively outputting a signal indicative of the detected fault.

14. The method of claim 13, wherein the fault is thermal runaway of a temperature of the respective one of the plurality of battery modules.

15. The method of claim 13, wherein the operating parameters include at least one of a voltage, temperature, impedance, pressure, and current of the respective one of the plurality of battery modules.

16. The method of claim 13, further comprising configuring at least one of the management modules to operate as a backup master management module in response to a determination that at least one of (i) a fault is detected in one of the plurality of battery modules, (ii) a fault is detected in the master management module, and (iii) a fault is detected in a communication network used by the master management module.

17. The method of claim 13, further comprising, using the diagnostic module, monitoring the operating parameters of the respective one of the plurality of battery modules in a sleep mode, wherein, in the sleep mode, at least one of the vehicle and a battery control module is powered off.

18. The method of claim 17, further comprising waking up the battery control module in response to detecting a fault in the respective one of the plurality of battery modules while in the sleep mode.

19. The method of claim 13, further comprising selectively transitioning one of the management modules to a broadcast beacon mode.

20. The method of claim 19, further comprising selectively transitioning the communication interface of the one of the management modules to the broadcast beacon mode in response to a determination that (i) a fault is detected in the respective one of the plurality of battery modules and (ii) a fault is detected in a wireless communication network.
